(19) United States
(12) Patent Application Publication
(10) Pub. No.: US 2018/0219452 A1
(43) Pub. Date: Aug. 2, 2018

(54) STATICALLY-BALANCED MECHANISM USING HALBACH CYLINDERS

(71) Applicants: HYDRO-QUÉBEC, Montréal (CA); UNIVERSITÉ LAVAL, Québec (CA)

(72) Inventors: Julien BOISCLAIR, Quebec (CA); Pierre-Luc RICHARD, Longueuil (CA); Thierry LALIBERTE, Quebec (CA); Clément GOSSELIN, Quebec (CA)

(21) Appl. No.: 15/748,443

(22) PCT Filed: Jul. 28, 2016
(86) PCT No.: PCT/CA2016/050891

§ 371 Date: Jan. 29, 2018

Related U.S. Application Data
(60) Provisional application No. 62/198,306, filed on Jul. 29, 2015.

(51) Int. Cl. H02K 7/04; B25J 19/00

(52) U.S. Cl. CPC H02K 7/04; H02K 5/15; Y10S 901/48; B25J 19/0008

(57) ABSTRACT

A mechanism comprises a first Halbach cylinder having an inner cavity, the first Halbach cylinder magnetized to produce a first magnetic flux concentrated circumferentially inside the inner cavity. A second Halbach cylinder is concentrically received in the inner cavity of the first Halbach cylinder to concurrently form a rotational joint having a rotational axis. One of the Halbach cylinders is a rotor and the other of the Halbach cylinders is a stator, the second Halbach cylinder magnetized to produce a second magnetic flux concentrated circumferentially outwardly. An output is connected to the rotor to rotate therewith relative to the stator, the output applying a gravity load on the rotor, the gravity load being offset from the rotational axis, whereby the magnetic flux of the first Halbach cylinder and the second Halbach cylinder cooperatively produce a torque against the gravity load caused by the output.

### CROSS-REFERENCE TO RELATED APPLICATION

The present application claims priority of U.S. provisional patent application Ser. No. 62/198,306, filed on Jul. 29, 2015, and incorporated herein by reference.

### TECHNICAL FIELD

The present disclosure relates to statically balanced mechanism of the type used in robotic applications.

### BACKGROUND OF THE ART

A mechanism is said to be statically balanced when the torque induced at its joint by the weight of the moving links, under static conditions, is not perceived by its actuators. This condition is achieved when the potential energy of the mechanism is constant in any of its configurations. Static balancing is vastly used to compensate for the weight of robotic manipulators to increase their performance. Advantages of such compensation may include augmented payload, increased safety, better dynamic response and/or reduced power.

Different design approaches have typically used to achieve gravity compensation. One such approach uses counterweights to compensate for the weight of the links. The counterweights can be mounted directly on the manipulator. The main advantage of this approach is that the center of mass of the mechanism is fixed for any given orientation of the gravity acceleration vector. This particularity is interesting when manipulators need to operate with their base mounted in an arbitrary orientation. However, the addition of counterweights on the manipulator also leads to drawbacks. The extra mass increases the inertia of the system and tends to decrease the performances. To reduce the harmful impact of counterweights, the latter can be moved aside of the manipulator and then mechanically coupled with cables or hydraulic transmissions. In such arrangements, the structure of the manipulator no longer needs to support the mass of the added counterweight. However, the articulations will still need to move the added inertia.

Another approach consists in storing potential energy into elastic components such as springs. This approach has the advantage of adding little mass and inertia to the system. On the other hand, the resulting mechanism tends to be more complex: it may lead to mechanical interferences and have a limited range of motion.

In such design choices, to achieve good performance, the balanced mechanism usually needs to be intrinsically integrated in the robot although it is possible to design a mechanism that can be retrofitted on an existing manipulator. The concept is similar to that of exoskeletons used in human rehabilitation. These methods are rarely used in robotics since the added mechanism is cumbersome. Moreover, the added mass and the restriction on the joint angular travel penalizes the overall performance of the robot.

### SUMMARY

It is an aim of the present disclosure to provide a balanced mechanism using Halbach cylinders.

Therefore, in accordance with the present disclosure, there is provided A mechanism comprising: a first Halbach cylinder having an inner cavity, the first Halbach cylinder magnetized to produce a first magnetic flux concentrated circumferentially inside the inner cavity; a second Halbach cylinder concentrically received in the inner cavity of the first Halbach cylinder to concurrently form a rotational joint having a rotational axis, wherein one of the first Halbach cylinder and the second Halbach cylinder is a rotor and the other of the first Halbach cylinder and the second Halbach cylinder is a stator, the second Halbach cylinder magnetized to produce a second magnetic flux concentrated circumferentially outwardly; and an output connected to the rotor to rotate therewith relative to the stator, the output applying a gravity load on the rotor, the gravity load being offset from the rotational axis, whereby the magnetic flux of the first Halbach cylinder and the second Halbach cylinder cooperatively produce a torque against the gravity load caused by the output.

Still further in accordance with the present disclosure, the second Halbach cylinder is the rotor.

Still further in accordance with the present disclosure, the output comprises a shaft projecting axially from the rotor.

Still further in accordance with the present disclosure, the second Halbach cylinder has an inner cavity receiving the shaft for concurrent relation between the rotor and the shaft.

Still further in accordance with the present disclosure, the shaft projects axially from opposite ends of the second Halbach cylinder.

Still further in accordance with the present disclosure, bearings are provided on the shaft at the opposite ends of the second Halbach cylinder, to rotatably support the second Halbach cylinder relative to the first Halbach cylinder.

Still further in accordance with the present disclosure, the first Halbach cylinder has end plates receiving the bearings.

Still further in accordance with the present disclosure, the output comprises a coupling plate at an end of the shaft.

Still further in accordance with the present disclosure, the first Halbach cylinder has a hollow cylindrical body with first longitudinal slots circumferentially surrounding the inner cavity, first magnets being received in each said first longitudinal slot.

Still further in accordance with the present disclosure, the first magnets received in the first longitudinal slots each have an arc-shaped section.

Still further in accordance with the present disclosure, the mechanism has twelve of the first magnets.

Still further in accordance with the present disclosure, the hollow cylindrical body has a titanium matrix.

Still further in accordance with the present disclosure, the second Halbach cylinder has a hollow cylindrical body with circumferentially-distributed second longitudinal slots, a second magnet being received in each said second longitudinal slot.

Still further in accordance with the present disclosure, the second magnets received in the second longitudinal slots each have an arc-shaped section.

Still further in accordance with the present disclosure, the mechanism has four of the second magnets.

Still further in accordance with the present disclosure, the hollow cylindrical body has an aluminum matrix.

Still further in accordance with the present disclosure, the first Halbach cylinder is magnetized to have a direction of magnetization with a single pair of poles according to Bᵣ=B cos(⊖); and B_{⊖}=B sin(⊖); wherein B is a magnitude of the magnet's magnetization, ⊖ is a location of the direction of magnetization along the first Halbach cylinder relative to a vector in a direction opposite to gravity, Bᵣ is a radial component and B_{⊖} is a tangential component.

Still further in accordance with the present disclosure, the first Halbach cylinder has a plurality of discrete magnets, wherein the direction of magnetization is an approximation of Bᵣ and of B_{⊖} using a location of each said discrete magnet for ⊖.

Still further in accordance with the present disclosure, the first Halbach cylinder is a single annular magnet.

Still further in accordance with the present disclosure, the first Halbach cylinder is magnetized to have a direction of magnetization with at least two pairs of poles according to Bᵣ=B cos(k⊖); and B_{⊖}=B sin(k⊖); wherein B is a magnitude of the magnet's magnetization, ⊖ is a location of the direction of magnetization along the first Halbach cylinder relative to a vector in a direction opposite to gravity, k is a number of pole pairs, Bᵣ is a radial component and B_{⊖} is a tangential component.

Still further in accordance with the present disclosure, the first Halbach cylinder has a plurality of discrete magnets, wherein the direction of magnetization is an approximation of Bᵣ and of B_{⊖} using a location of each said discrete magnet for ⊖.

Still further in accordance with the present disclosure, the first Halbach cylinder is a single annular magnet.

Still further in accordance with the present disclosure, the first Halbach cylinder has k pairs of poles, k being at least two.

Still further in accordance with the present disclosure, the output comprises a reduction mechanism between the rotor and the gravity load, the reduction mechanism reducing a rotation of the gravity load relative to the rotor in a ratio of k:1.

Still further in accordance with the present disclosure, an assembly comprises at least two of the mechanism described above, wherein the outputs of the rotors of the at least two mechanisms are coupled axially to combine torque of the mechanisms.

Still further in accordance with the present disclosure, an assembly comprises at least two of the mechanism described above, wherein a stator of a first one of the mechanism is configured to be secured to a structure, and the output of the first mechanism is a first link connecting a rotor of the first mechanism to a stator of a second one of the mechanisms.

Still further in accordance with the present disclosure, the output of the second mechanism is a second link connecting a rotor of the second mechanism to a stator of a third one of the mechanisms.

Still further in accordance with the present disclosure, a rotational joint is provided between each set of the links and the stators.

Still further in accordance with the present disclosure, a transmission is between the stators of each pair of the mechanisms connected by one said link, for the stators to remain align with gravity.

Still further in accordance with the present disclosure, the transmission includes one of pulleys and belt, pinions and chain, and gears and belt.

### DESCRIPTION OF THE DRAWINGS

FIG. 1 is a schematic view of a Halbach array with cubic magnets;

FIG. 2A is a schematic end view of an external-field Halbach cylinder showing flux for a dipolar configuration of a one pole pair;

FIG. 2B is a schematic end view of an external-field Halbach cylinder showing flux for a quadripolar configuration of two pole pairs;

FIG. 2C is a schematic end view of an internal-field Halbach cylinder showing flux for a dipolar configuration of one pole pair;

FIG. 2D is a schematic end view of an internal-field Halbach cylinder showing flux for a quadripolar configuration of two pole pairs;

FIG. 3 is a schematic view of a core of a balanced mechanism in accordance with the present disclosure;

FIG. 4 is a schematic view of geometric parameters used to describe the architecture of the core of a balanced mechanism of FIG. 3;

FIG. 5 is a perspective view of an embodiment of balanced mechanism of FIG. 3;

FIG. 6 is an assembly view of the balanced mechanism of FIG. 5;

FIG. 7 is a sectional view of the balanced mechanism of FIG. 5;

FIG. 8 is a schematic view of an embodiment of a magnet distribution for the balanced mechanism of FIG. 5;

FIG. 9 is a schematic perspective view of coupled balanced mechanisms in accordance with the present disclosure;

FIG. 10 is a schematic elevation view of 3-link serial arms with interaction balanced mechanisms in accordance with the present disclosure; and

FIG. 11 is a schematic view of a balanced mechanism, with a reduction mechanism for a two pole pair configuration.

### DETAILED DESCRIPTION

This present disclosure proposes a balancing approach that uses permanent magnets to produce the torque needed to compensate gravity. The proposed concept, based on concentric motion of Halbach cylinders, allows an axial integration to the joint actuator which may reduce interference with existing designs. Moreover, by using the proper type of magnets and magnetization discretization, a sinusoidal torque that matches gravity over a complete rotation of 360° can be obtained

The proposed balancing concept is based on the interaction between the fields produced by magnets. The bipolar nature of any magnet generates a magnetic field B, measured in Tesla (T), around its surface. Also called magnetic flux density or magnetic induction, this vector field is characterized by a direction and an orientation in space. The magnetic field strength H, measured in ampere per meter (A/m), corresponds to the density of the B-field at a given point in space. The relation between these two quantities is:

B=μ₀(M+H)

where μ₀ is the vacuum permeability, and M is the magnetization of the material. The magnetization represents the intensity of the dipoles the magnet can create within itself. Permanent magnets may be chosen over electromagnets because they do not require power to produce a magnetic field thus allowing the mechanism to act passively on the articulation. Moreover, permanent magnets are typically more powerful than electromagnets for a given weight. Nonetheless, electromagnets could be used in a balanced mechanism according to the present disclosure.

The intensity of the magnetic field dictates the magnitude of the attraction and repulsion force resulting from the interaction. However, the intensity of the field around a permanent magnet decreases rapidly as the distance to the magnet's surface increases. Hence, it may be desired that the magnets remain close to each other. Therefore, concepts based on linear displacement between magnets have a very limited potential. Instead, a circular motion of initially aligned magnets is selected, to create a torque between the magnets.

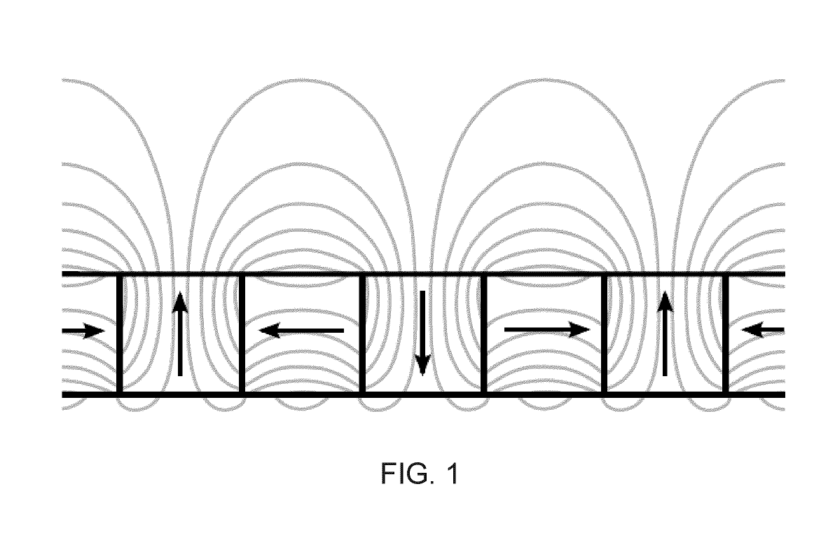

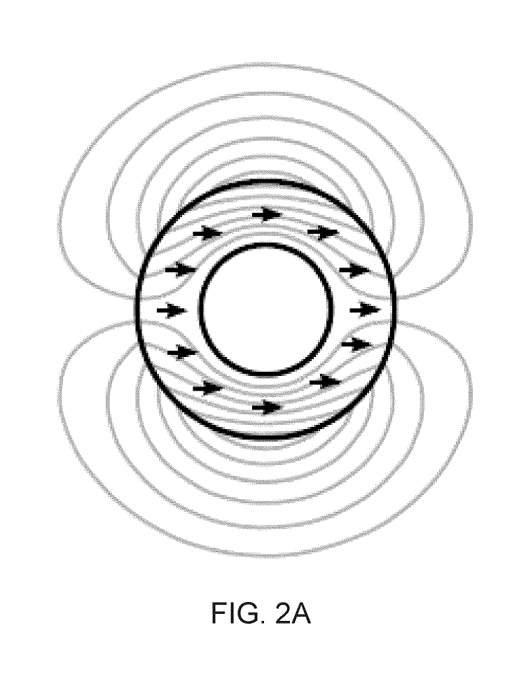

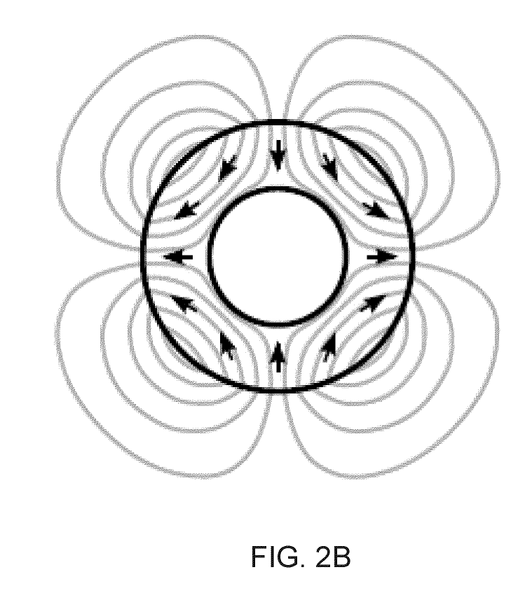

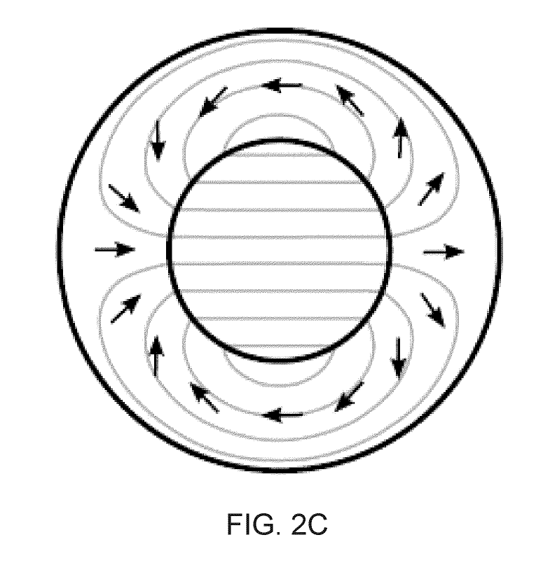

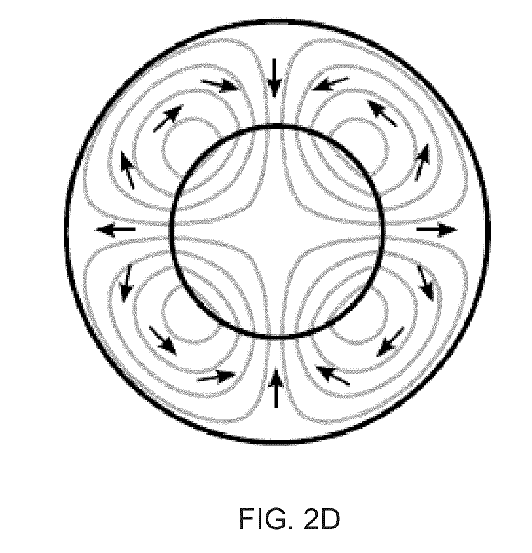

When the magnetization in the magnet is unidirectional, the resulting field around the surface is symmetrical. However, it is possible to concentrate the field on a specific side of the magnet, while canceling it on the other side, by using a special magnetization pattern called the Halbach Array. The array in its linear discrete form is shown in FIG. 1, the squares representing the magnets, the arrows representing the direction of the magnetization and the lines representing the magnetic potential. To obtain rotational movement, the array can be shaped into a circle to form a Halbach cylinder, as shown in FIGS. 2A to 2D. The resulting magnetic flux is then concentrated outside or inside the cylinder with a certain number of pole pairs. i.e., circumferentially outwardly and circumferentially inwardly, respectively. External-field Halbach cylinder C1 with a one and two pole pairs array are shown in FIGS. 2A-2B respectively, whereas internal-field Halbach cylinder C2 with a one and two pole pairs array are shown in FIGS. 2C-2D, respectively. The magnetization's direction inside the Halbach cylinder magnet varies continuously according to

Bᵣ=B cos(k⊖); (1)

B_{⊖}=B sin(k⊖); (2)

where B is the magnitude of the magnet's magnetization, ⊖ is the location of the direction along the Halbach cylinder relative to a vector in a direction opposite to gravity, Bᵣ is its radial component and B_{⊖} is its tangential component. The integer k denotes the number of pole pairs, a positive value means an internal configuration.

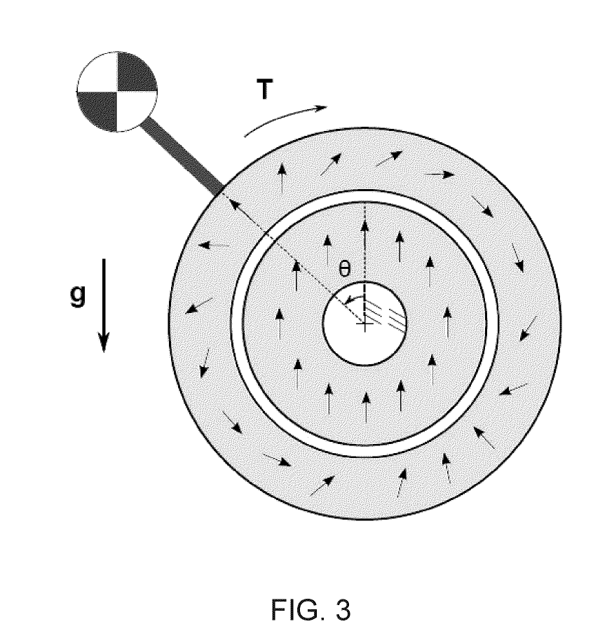

Referring to FIG. 3, a balanced mechanism 10 in accordance with the present disclosure is built by nesting an external-field Halbach cylinder C1 as in FIGS. 2A-2B in an internal-field Halbach cylinder C2 as in FIGS. 2C-2D, with a rotational degree of freedom enabling a rotation of cylinder C2 relative to cylinder C1. The torque T is generated by the weight of a load on cylinder C1 as a function of its orientation ⊖ relative to the concentric cylinder C2.

The uniform magnetic field generated in the center of a Halbach cylinder is useful in applications such as nuclear magnetic resonance (NMR), particle accelerator and magnetic cooling. One of the challenges in the above-referred applications of NMR, particle accelerator and magnetic cooling is to optimize the fields homogeneity and intensity while minimizing the volume of magnet required. The parametric optimization used to achieve this goal is for example presented in Bjørk, R., Bahl, C. R. H., Smith, A., and Pryds, N., 2008. “Optimization and improvement of Halbach, cylinder design”. Journal of Applied Physics, 104(1), p. 013910. For a two dimensional case, analytical solutions exist for the magnetic field inside an Halbach array, for example in Bjørk, R., Smith, A., and Bahl, C., 2010. “Analysis of the magnetic field, force, and torque for twodimensional Halbach cylinders”. Journal of Magnetism and Magnetic Materials, 322(1), pp. 133-141. However, since the proposed balanced mechanism focuses on torque generation, the latter results cannot be directly applied. Moreover, the three-dimensional attraction and repulsion interactions between cylinders arranged in the mechanism 10 of FIG. 3 may be too complex to yield an analytical solution. Instead, to approach an optimal Halbach array for the balanced mechanism 10 of FIG. 3, the effects of the parameters is studied individually by computing a numerical solution, for example using COMSOL™ Multiphysics. The results of the simulations may then be used as guidelines in the design of a required Halbach array.

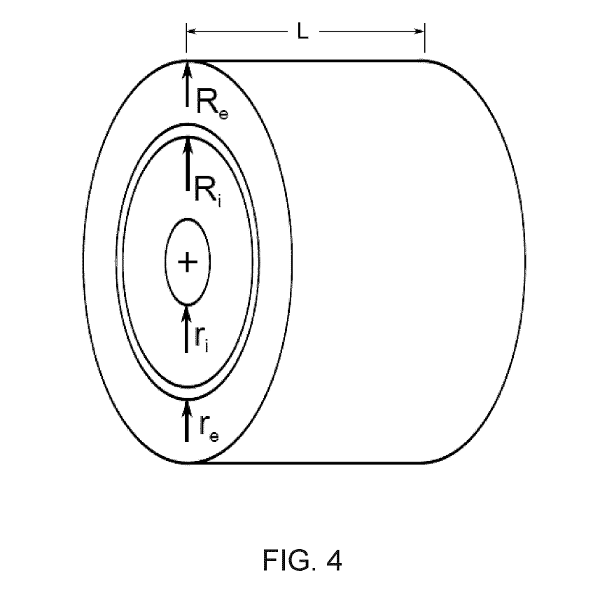

Starting with the parameters shown in FIG. 4, the following non-dimensional ratios are introduced to better characterize the geometry.

$$\begin{matrix}a = \frac{{R}_{e} - {r}_{e}}{{R}_{i} - {r}_{i}} & ( 3 ) \\ β = \frac{L}{2 {R}_{e}} & ( 4 )\end{matrix}$$

Where α is referred to as the thickness ratio, while β is referred to as the shape ratio.

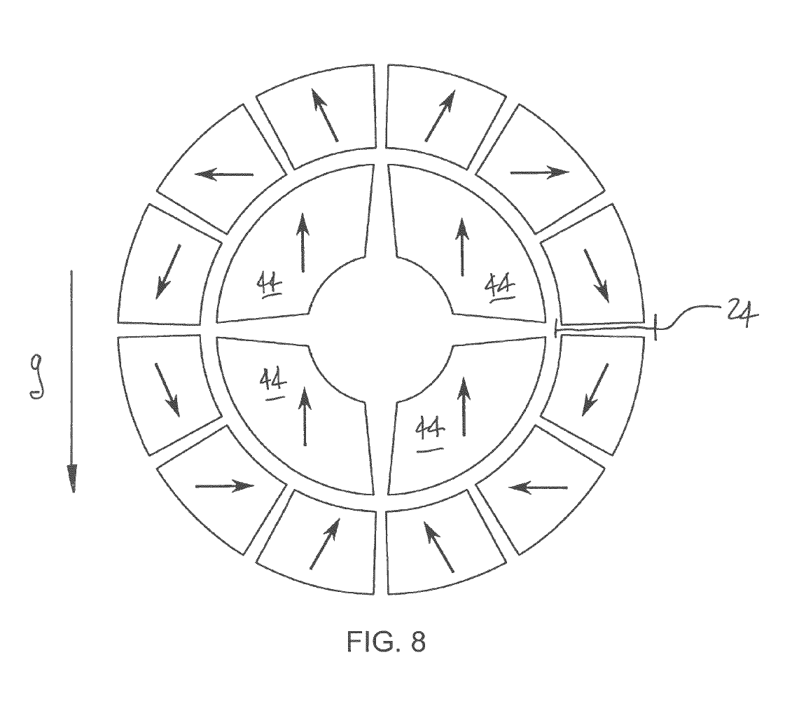

Firstly, the effect of the number of pole pairs is investigated. The torque produced by the nested cylinders as in FIGS. 3 and 4 can match the gravity only if there is a single pole pair. However, the movement of a configuration using two pole pairs and more can potentially be geared down to obtain the same behaviour as that obtained with a single pole pair configuration. Using a bipolar configuration means a simpler mechanical design but, configurations with more pole pairs have a higher output torque even after gear reduction. Even though quadripolar configurations have more potential than a bipolar configuration, the need of a transmission in the mechanism leads to several drawbacks such as friction, increased mass and the space required for the transmission. For these reasons the rest of this investigation focuses on single pole pair configurations. Nevertheless, the results obtained can be extended to multi-pole pair configurations. In particular, the embodiments of FIGS. 3 and 8 described in more detail below, show a single pole pair, but the embodiments of FIGS. 3 and 8 could also feature more than a single pole pair (e.g., based on the fields of FIGS. 2B and 2D).

The Halbach array can be shaped in radius and in length to best suit the space allowed by a given application. However, specific ratios between the array's dimensions maximize the produced torque, for a given magnet volume. As a general trend, with an increase of the volume, there is a linear increase of the maximal torque for any shape ratio β. In some particular embodiments, a larger geometry may be preferable over multiple smaller ones, due to the higher torque, although other applications may be better suited for smaller geometries. Also, as a general trend, higher shape ratios improve the torque capacity.

Other parameters such as the inner diameter Ri and the air gap between the cylinders (re-Ri) also have an impact on the maximum torque, as decreasing the gap (re-Ri) to a functional minimum will increase the maximal torque. However, these parameters are linked to the mechanical design. For example, space may be required in the inner cylinder C1 to fit a coupling mechanism.

The magnetization process of permanent magnets consists in applying a very high magnetic field through the magnet. Thereafter, the magnet will keep a fraction of the applied field. If a unidirectional magnetization orientation is desired, the process is straightforward. However, complex orientations such as the ones shown in FIGS. 2A to 2D require special magnetization setups, examples of which are described in Zhu, Z., Xia, Z., Atallah, K., Jewell, G., and Howe, D., 2000. “Powder alignment system for anisotropic bonded NdFeB Halbach cylinders”. Magnetics, IEEE Transactions on, 36(5), pp. 3349-3352 or Atallah, K., and Howe, D., 1998. “The application of Halbach cylinders to brushless ac servo motors”. Magnetics, IEEE Transactions on, 34(4), pp. 2060-2062. Continuous magnetization of the magnets in the Halbach cylinders offers the maximal output torque, but the methods needed to obtain such patterns are costly.

Alternative designs may thus be considered using more common magnets. By using discrete magnets, the magnetization process may be simplified since standard methods can be applied. Moreover, the discretization of the magnets used in combination with orientation markers on the magnets and on a support matrix may ensure the magnets are properly arranged to create the Halbach effect. On the other hand, using more magnets to construct a Halbach array may result in a more complicated and bulkier design.

Standard shapes such as cylinders or cubes can be used to approximate continuous magnetization in the Halbach cylinders, based in equations (1) and (2) and a location of the discrete magnets along the Halbach cylinder. Using this approach, the cost of the array is greatly reduced but the low magnet density, caused by the gap between magnets, generates a relatively low output torque. Moreover, if cylindrical discrete magnets are used, some calibration must be performed to align the direction of magnetization of the magnets based on equations (1) and (2), and care must be taken for the cylindrical discrete magnets not to rotate during use.

An alternative to this approach is to use arc-shaped magnets. The resulting magnet density is higher, thus increasing the maximal torque. Moreover, the produced torque of an arc-shaped geometry is a function of the number of segments used to build the pattern. As the number of arc-segments increases, the maximal torque produced by the mechanism approach an optimum. In a practical design, a segmentation (for example into arc-shaped magnets or in any other shape) may be desirable to ease the handling and integration of the magnets. However, if the design requires gaps between the magnets of the inner cylinder C1, the torque behaviour may not fit with the torque induced by gravity.

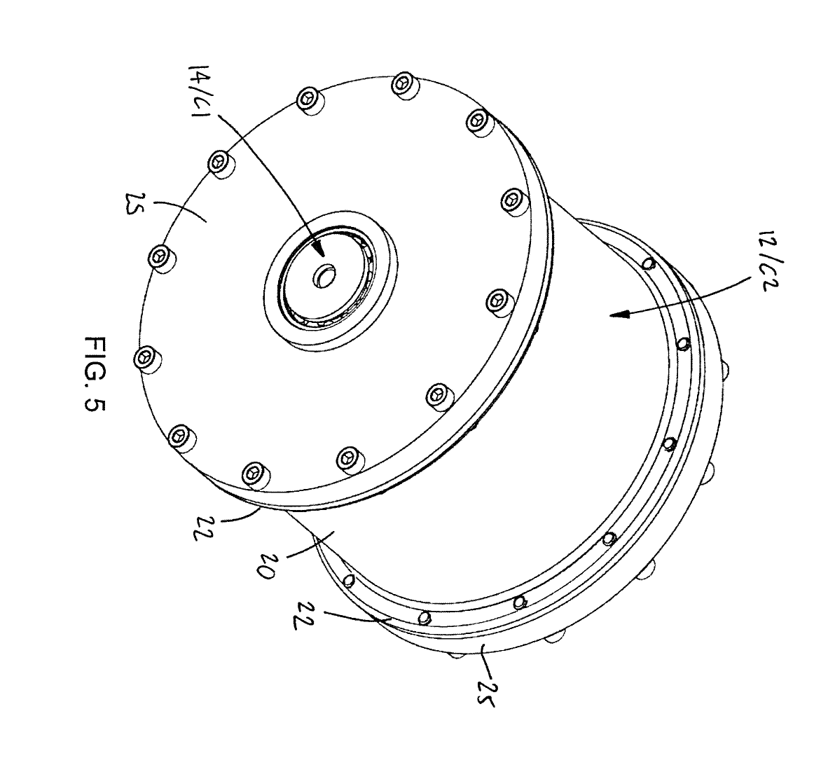

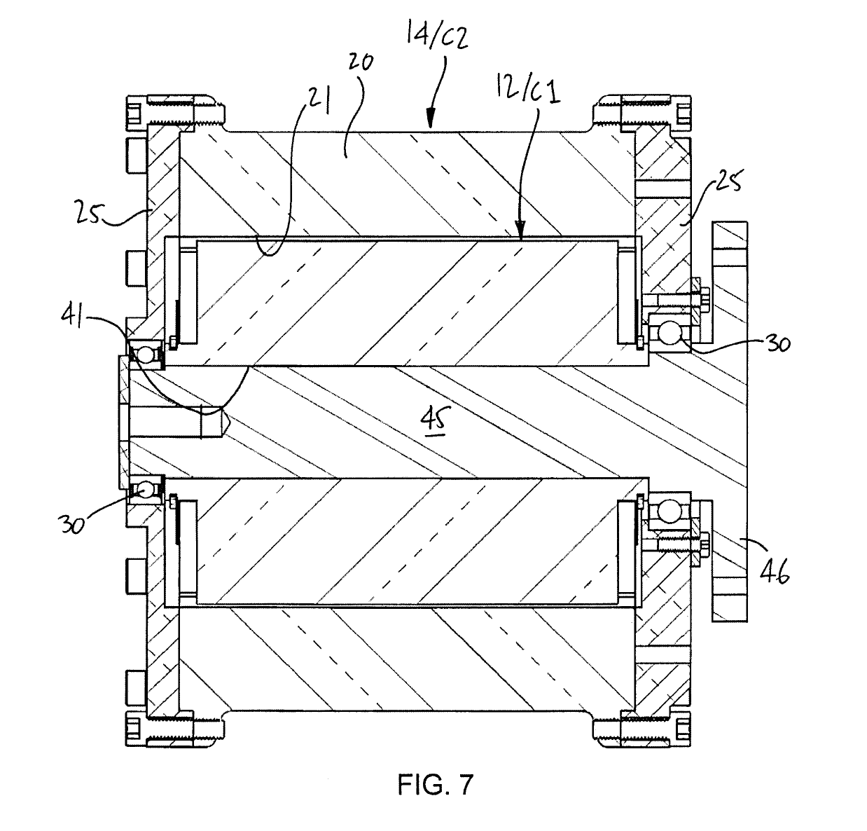

Referring to FIGS. 5 to 8, an embodiment of the balanced mechanism 10 is shown in greater detail, featuring the inner cylinder C1 and the outer cylinder C2. In the illustrated embodiment, the outer cylinder C2 is part of the stator 12 of the balanced mechanism 10, whereas the inner cylinder C1 is part of the rotor 14, although it is contemplated to have the opposite arrangement. In the illustrated embodiment, the inner cylinder C1 may be driven by an actuator (e.g., a motor) while the outer cylinder C2 is a support structure for the inner cylinder, although the opposite arrangement would have it differently.

The stator 12 has a cylindrical body 20 defining an inner cavity 21 for rotatably receiving therein the rotor 14, making the cylindrical body 20 a hollow cylinder. Flanges 22 project radially outwardly from ends of the cylindrical body 20. Although various materials may be used for the cylindrical body 20 (e.g., plastic, aluminum, brass, stainless steel, etc), a titanium matrix is well suited to perform the functionalities described below. The cylindrical body 20 has longitudinally aligned slots 23, twelve in the illustrated embodiment, each configured to receive an arc-shaped magnet 24, or magnets of any appropriate shape. The magnets 24 form a segmented arrangement of magnets to create the circumferentially inward flux of the Halbach effect for the stator 12, i.e., the Halbach cylinder C2. End plates 25 are attached to the flanges 22 on the opposite ends of the cylindrical body 20, whereby the rotor 14 and the magnets 24 are held captive in the stator 12. The combination of flanges 22 and end plates 25 are one among many arrangements considered to enclose components in the cylindrical body 20. As the stator 12 is the structural component in the illustrated embodiment, attachment bores may be distributed on one of the end plates 25, such as the end plate 25 that is on the opposite side of an output shaft projecting axially away from one of the end plates 25.

The end plates 25 may support the outer race of bearings 30, which bearings 30 are used to rotatably support the rotor 14, such that a rotational degree of freedom is provided between the stator 12 and the rotor 14, about common rotational axis X.

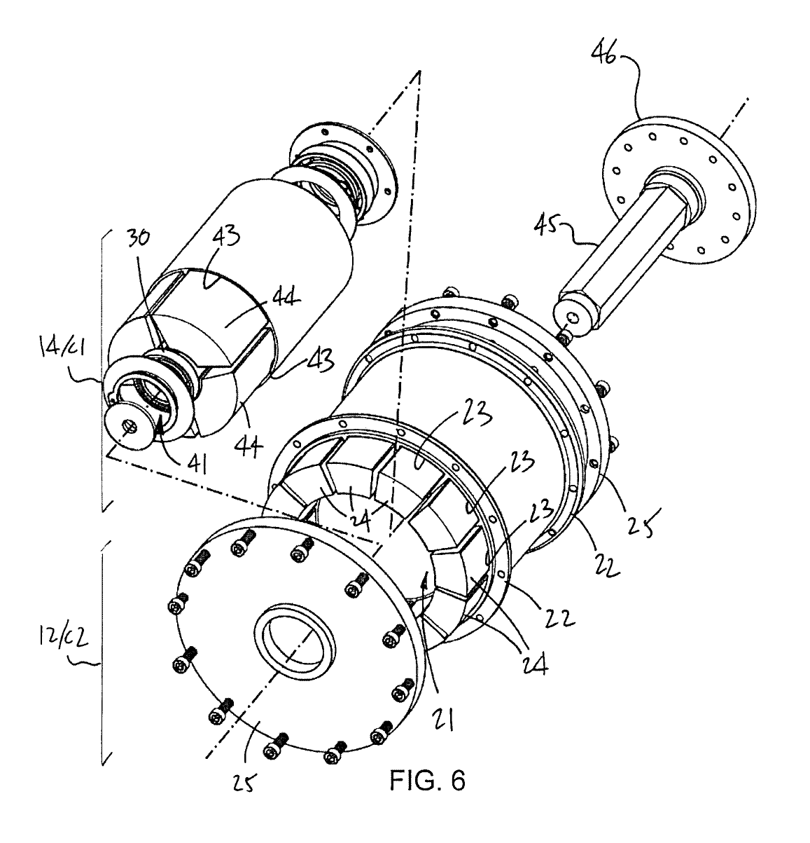

Referring to FIGS. 6-8, the rotor 14 has a cylindrical body 40 having an outer surface sized to be received in the inner cavity 21 of the stator 12 with minimum gap. The cylindrical body 40 defines an inner cavity 41, making the cylindrical body 40 a hollow cylinder. Although various materials may be used for the cylindrical body 40 (e.g., plastic, titanium, brass, stainless, etc), an aluminum matrix is well suited to perform the functionalities described below. The cylindrical body 40 may have longitudinally aligned slots 43, four in the illustrated embodiment, each configured to receive an arc-shaped magnet 44, or magnets of any appropriate shape. The magnets 44 form a segmented arrangement of magnets to create the circumferentially outward flux of the Halbach effect for the rotor 14, i.e., the Halbach cylinder C1.

A shaft 45 is received in the inner cavity 41 and is integrally connected to the cylindrical body 40 so as to rotate with it. The shaft 45 projects axially away from one of the end plates 25 and may comprise any appropriate load support, for being connected to any eccentrically positioned load, i.e., offset from the rotational axis X. In the illustrated embodiment, the load support is a circular coupling plate 46, with circumferentially distributed tapped bores. An opposed end of the shaft 45 may be configured to be connected to a degree of actuation, or vice versa.

Referring to FIG. 8, a magnetization arrangement is shown for both sets of magnets 24 and 44, with the arrows representing the direction of magnetization, for a single pole pair, although multiple pole pairs could be used with the limitations described above. The magnetization arrangement is such that the stator 12 and the rotor 14 cooperatively produce torque against any gravity load applied eccentrically on the rotor 14, the gravity vector being shown as g. The angles of the directions of the magnets 24 and 44 are representative of a magnetization arrangement that substantially compensate the effect of gravity over 360°. The magnetization arrangement is similar to that of FIG. 3, and may be described as follows:

The magnets 44 of the rotor 14 all have a direction of magnetization generally opposite to a gravity vector to create an external field (±10 degrees), and aligned with the load applying the torque. For the balanced mechanism 10 to be statically balanced, the magnets 24 of the stator 12 generate an internal magnetic field by having the direction of magnetization described below, as detailed relative to a plane of the stator 12 normal to its longitudinal axis, using for convention the gravity vector being at 6h00 on the stator 12, while 0 degree is a vector directed to 3h00 on the stator 12, 90 degrees is a vector directed to 12h00, 180 degrees is a vector direction to 9h00, and 270 degrees is a vector directed to 6h00. The direction of magnetization is determined by an approximation of the equations (1) and (2) provided above. For example, for the magnet located immediately clockwise of 12h00, an approximation could have ⊖ taken at any value of the annular segment covered by the discrete magnet, although a median value may be well suited to provide a suitable approximation. Hence, starting at 12h00, in a clockwise direction, the direction of magnetization for 12 magnets 44 may be approximated as, sequentially: 60°, 0°, 300°, 240°, 180°, 120°, 60°, 0°, 300°, 240°, 180°, 120°. The magnets of the stator 12 are all at 90°.

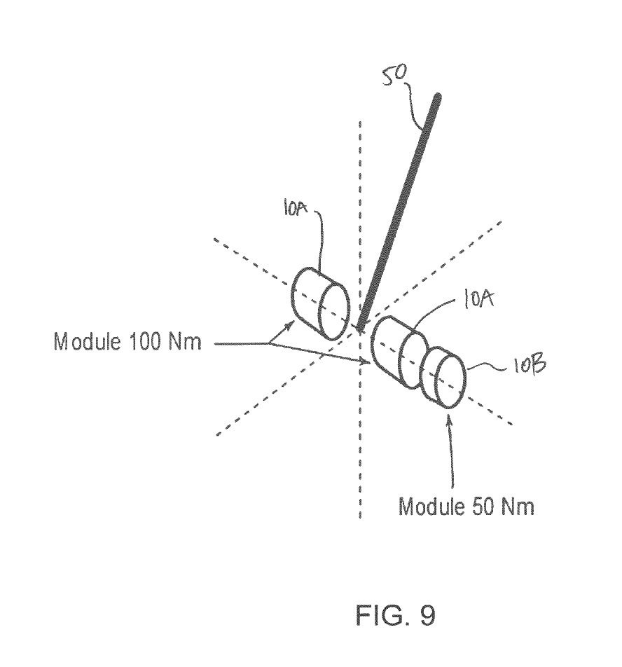

Referring to FIG. 9, an arrangement is shown in which balanced mechanisms 10 are coupled axially to concurrently produce a combined torque. For example, balanced mechanisms 10A could be for example 100 Nm modules, whereas balanced mechanism 10B could be a 50 Nm module, for balancing an arm 50 with a total of 250 Nm torque. This would require the coupling of the rotors of the balanced mechanisms 10A and 10B, but could represent a modular configuration to customize sets of the balanced mechanisms for a given load.

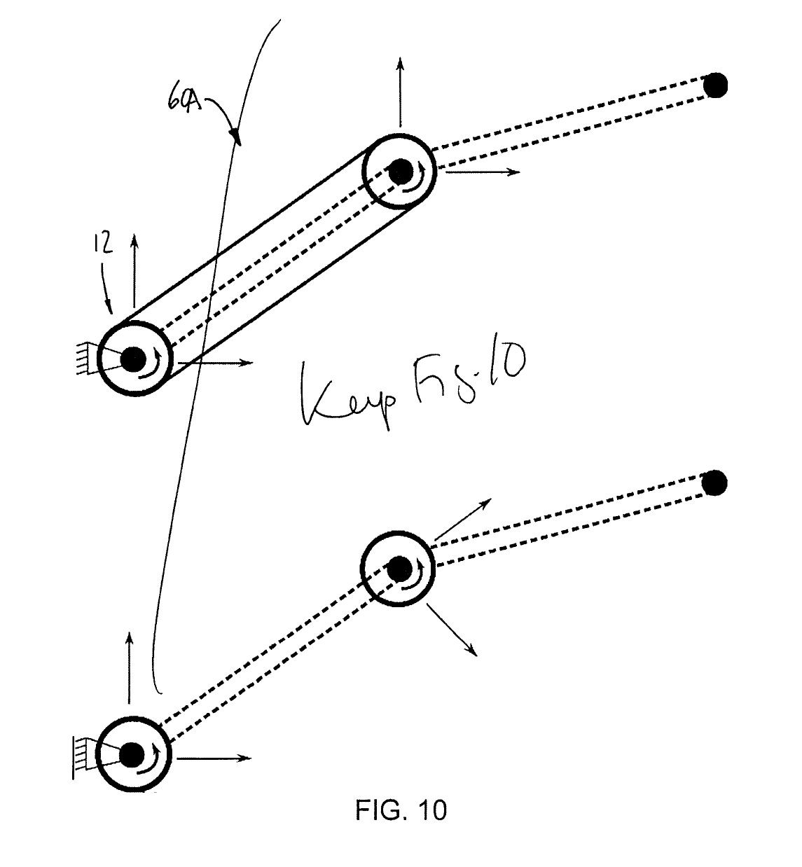

Referring to FIG. 10, 3-link serial arms are respectively shown as 60A and 60B. The serial arms 60A and 60B are shown as being constituted of three links 70, but could have two or more links, in similar arrangements. In the serial arm 60A, the stators of the balanced mechanisms 10 are coupled by a transmission 80, for example a pulley and belt, in such a way that the stators may retain their alignment with gravity, due to the fact that a base stator is fixed to a structure as illustrated. Two of the links 70 connect a rotor to a stator, but with a rotational joint between the end of the links 70 and the stator, to allow the stators to retain their gravity alignment. Other transmissions may include a geared transmission, chain and pinions, etc. In the serial arm 60B, there is no such transmission between the rotors, such that gravity reference is not maintained through movements of the serial arm 60B.

Various factors may be considered for the construction of a prototype of the magnetic balanced mechanism 10.

In terms of magnet selection, permanent magnets may be more practical than electromagnetic, notably by the absence of powering. For permanent magnets, the remanent induction, the Curie temperature and the coercivity may be relevant.

Denoted Br, the remanent induction is the value of the magnetization inside the magnet when no external field is applied. Remanent induction is the result of the magnetization process and is given by the manufacturer. Higher remanent induction values increase the magnetic field intensity around the magnet.

Denoted Tc, the Curie temperature is the temperature at which the magnet loses its magnetization permanently. However, if carried through the magnetization process again, the magnet can regain its initial induction. The properties and performance of magnet generally decrease when the temperature increase. Their operation point must be far away from their Curie temperature.

Denoted Hc, the coercicity is the magnetic field, inverse to the magnetization, required to cancel the magnetization inside the magnet. Permanent magnets lose a fraction of their remanent induction if exposed to a high inverse magnetic field. The coercivity roughly represents the resistance of the magnet to demagnetization.

As examples of magnets well suited to be used in the balanced mechanism 10, rare-earth magnets are relative expensive and their fabrication is also more complex, thus limiting the possible shapes. The first important subclass is the neodymium magnet, with adequate remanent induction and coercivity, which make them adequate in permanent magnet balanced mechanisms 10. On the other hand, such magnets have poor resistance to temperature increases and their susceptibility to corrosion requires coating. Like the neodymium magnets, cobalt magnets have good magnetic properties. Their remanent induction and coercivity are slightly below those of the neodymium magnets but their temperature and corrosion resistance are superior. The main drawback of cobalt magnets is their cost.

Although types of magnets may be used, yet with properties that render them not as suitable as the rare-earth magnets, such as ferrite magnets and AlNiCo magnets. Magnets such as the ones presented above may be brittle and fragile. These magnets can be combined to a polymer to obtain better structural properties at the expense of magnetic properties.

The demagnetization in the pattern is an important effect to consider in the mechanism design and the magnet selection. If the magnetic field inside the magnet is opposed to the magnetization and is above a certain threshold, the magnet can undergo permanent remanent induction losses. The behaviour of magnetic materials in the presence of an external magnetic field is obtained from the intrinsic hysteresis curve, i.e., the effect of an external field H on the properties of the magnet, such as the magnetization, and the normal hysteresis curves characterizing the effect of an external field on the net magnetic flux or magnetic induction inside the magnet

If lower grade magnets are used, it is contemplated to use shielding techniques to reduce demagnetization. With their high magnetic permeability, iron pieces may be used to channel the magnetic field, reducing demagnetization in adjacent magnets. In addition, an iron shield may be added around the diameter of the whole geometry to reduce demagnetization and limit the magnetic flux leakage through the outer diameter. While limiting the demagnetization, the addition of iron pieces also reduces the produced torque.

The proposed design allows easy retrofitting of existing articulations with little drawbacks. By using series of magnets arranged in a Halbach array, a torque matching the gravity is produced. The resulting mechanism can be easily integrated in most designs since it can be added axially on an articulation. The range of motion of the proposed mechanism is not limited, eliminating the possible interferences. Also, since the torque is produced via magnetic interaction, reduced friction is added to the system.

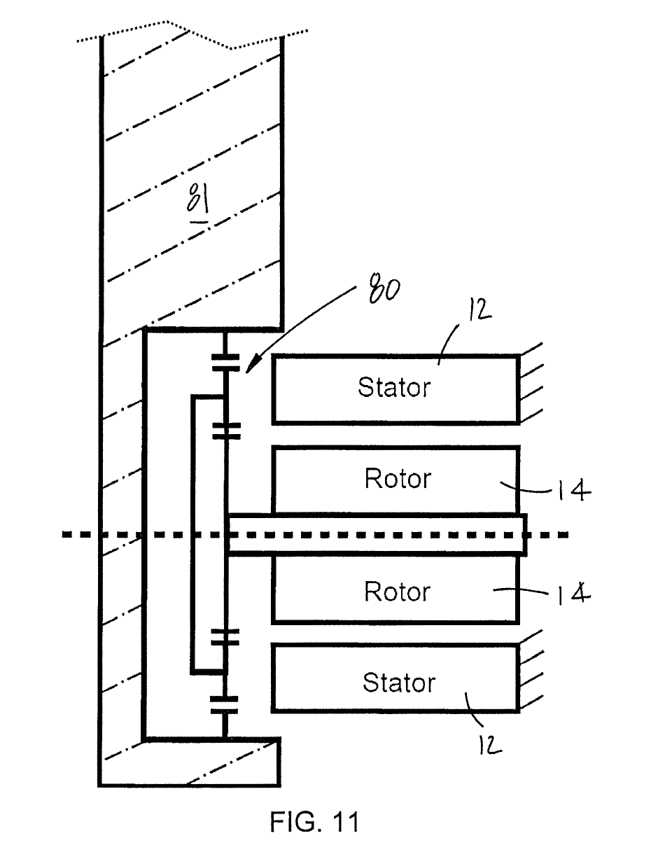

Referring to FIG. 11, the balanced mechanism 10 is of the type having a two pole pair configuration, for example of the type shown in FIGS. 2B and 2D. A two pole pair configuration produces a sinusoidal torque over 180 degrees. Accordingly, in order to match the torque with the gravity, reduction mechanism 80 may be used for arm 81 to do a single rotation for two complete rotations of the rotor 14 (2:1). The reduction mechanism 80 is any appropriate reduction mechanism, for example of the planetary type. The same principle applies in order to further increase the reduction ratio. For example, the balanced mechanism 10 could have a four pole pair configuration, with a 4:1 reduction mechanism.

1. A mechanism comprising:
a first Halbach cylinder having an inner cavity, the first Halbach cylinder magnetized to produce a first magnetic flux concentrated circumferentially inside the inner cavity;
a second Halbach cylinder concentrically received in the inner cavity of the first Halbach cylinder to concurrently form a rotational joint having a rotational axis, wherein one of the first Halbach cylinder and the second Halbach cylinder is a rotor and the other of the first Halbach cylinder and the second Halbach cylinder is a stator, the second Halbach cylinder magnetized to produce a second magnetic flux concentrated circumferentially outwardly; and
an output connected to the rotor to rotate therewith relative to the stator, the output applying a gravity load on the rotor, the gravity load being offset from the rotational axis, whereby the magnetic flux of the first Halbach cylinder and the second Halbach cylinder cooperatively produce a torque against the gravity load caused by the output.

2. The mechanism of claim 1, wherein the second Halbach cylinder is the rotor.

3. The mechanism of claim 2, wherein the output comprises a shaft projecting axially from the rotor.

4. The mechanism of claim 3, wherein the second Halbach cylinder has an inner cavity receiving the shaft for concurrent relation between the rotor and the shaft.

5. The mechanism of claim 2, wherein the shaft projects axially from opposite ends of the second Halbach cylinder

6. The mechanism of claim 5, further comprising bearings on the shaft at the opposite ends of the second Halbach cylinder, to rotatably support the second Halbach cylinder relative to the first Halbach cylinder.

7.-8. (canceled)

9. The mechanism of claim 1, wherein the first Halbach cylinder has a hollow cylindrical body with first longitudinal slots circumferentially surrounding the inner cavity, first magnets being received in each said first longitudinal slot.

10. The mechanism of claim 9, wherein the first magnets received in the first longitudinal slots each have an arc-shaped section.

11. (canceled)

12. The mechanism of claim 9, wherein the hollow cylindrical body has a titanium matrix.

13. The mechanism of claim 1, wherein the second Halbach cylinder has a hollow cylindrical body with circumferentially-distributed second longitudinal slots, a second magnet being received in each said second longitudinal slot.

14. The mechanism of claim 13, wherein the second magnets received in the second longitudinal slots each have an arc-shaped section.

15. (canceled)

16. The mechanism of claim 13, wherein the hollow cylindrical body has an aluminum matrix.

17. The mechanism of claim 1, wherein the first Halbach cylinder is magnetized to have a direction of magnetization with a single pair of poles according to
Bᵣ=B cos(⊖); and
B_{⊖}=B sin(⊖);
wherein B is a magnitude of the magnet's magnetization, ⊖ is a location of the direction of magnetization along the first Halbach cylinder relative to a vector in a direction opposite to gravity, Bᵣ is a radial component and B_{⊖} is a tangential component.

18. The mechanism of claim 17, wherein the first Halbach cylinder has a plurality of discrete magnets, wherein the direction of magnetization is an approximation of Bᵣ and of B_{⊖} using a location of each said discrete magnet for ⊖.

19. The mechanism of claim 17, wherein the first Halbach cylinder is a single annular magnet.

20. The mechanism of claim 1, wherein the first Halbach cylinder is magnetized to have a direction of magnetization with at least two pairs of poles according to
Bᵣ=B cos(k⊖); and
B_{⊖}=B sin(k⊖);
wherein B is a magnitude of the magnet's magnetization, ⊖ is a location of the direction of magnetization along the first Halbach cylinder relative to a vector in a direction opposite to gravity, k is a number of pole pairs, Bᵣ is a radial component and B_{⊖} is a tangential component.

21. The mechanism of claim 20, wherein the first Halbach cylinder has a plurality of discrete magnets, wherein the direction of magnetization is an approximation of Bᵣ and of B_{⊖} using a location of each said discrete magnet for ⊖.

22. The mechanism of claim 20, wherein the first Halbach cylinder is a single annular magnet.

23. The mechanism of claim 1, wherein the first Halbach cylinder has k pairs of poles, k being at least two.

24. The mechanism of claim 23, wherein the output comprises a reduction mechanism between the rotor and the gravity load, the reduction mechanism reducing a rotation of the gravity load relative to the rotor in a ratio of k:1.

25.-30. (canceled)
